(19) United States
(12) Patent Application Publication
(10) Pub. No.: US 2015/0274957 A1
(43) Pub. Date: Oct. 1, 2015

(54) POLARIZING PLATE PROTECTIVE FILM, POLARIZING PLATE, LIQUID CRYSTAL DISPLAY DEVICE, AND PRODUCTION METHOD OF POLARIZING PLATE PROTECTIVE FILM

(71) Applicant: FUJIFILM CORPORATION, Tokyo (JP)

(72) Inventors: Kenichi FUKUDA, Kanagawa (JP); Masaaki SUZUKI, Kanagawa (JP)

(73) Assignee: FUJIFILM CORPORATION, Tokyo (JP)

(21) Appl. No.: 14/670,482

(22) Filed: Mar. 27, 2015

(30) Foreign Application Priority Data
Mar. 31, 2014 (JP) 2014-074483

(51) Int. Cl. C08L 33/08; G02B 5/30; C08L 33/14; G02F 1/1335

(52) U.S. Cl. CPC C08L 33/08; G02F 1/133528; G02B 5/3083; C08L 33/14

(57) ABSTRACT

There is provided a polarizing plate protective film comprising a substrate film, and a layer formed by curing a curable composition containing, setting a total solid content of the curable composition to 100 mass %, from 50 to 90 mass % of the following (A) and from 10 to 40 mass % of the following (B) based on the total solid content, (A) a compound having three or more ethylenically unsaturated double bonds in the molecule, and (B) a rosin compound having an acid value of 150 to 400 mgKOH/g.

### CROSS-REFERENCE TO RELATED APPLICATIONS

This application claims priority from Japanese Patent Application No. 2014-74483, filed on Mar. 31, 2014, the contents of all of which are hereby incorporated by reference in their entirety.

### BACKGROUND OF THE INVENTION

1. Field of the Invention

The present invention relates to a polarizing plate protective film, a polarizing plate, a liquid crystal display device, and a production method of a polarizing plate protective film.

2. Description of the Related Art

In recent years, a liquid crystal display device is widely used in applications such as liquid crystal panel of a liquid crystal television, a personal computer, a cellular phone, a digital camera, etc. Usually, the liquid crystal display device has a liquid crystal panel member fabricated by providing a polarizing plate on both sides of a liquid crystal cell, and display is performed by controlling light from a backlight member by the liquid crystal panel member. Here, the polarizing plate consists of a polarizer and at lease one protective film (polarizing plate protective film).

With the recent quality enhancement of a liquid crystal display device, the usage is diversified and the demand for durability becomes strong. For example, stability against an environmental change is required in use for an outdoor application, and it is required that a polarizing plate protective film used for the liquid crystal display device is also kept from a change in the dimension or optical properties due to a temperature or humidity change.

JP-A-2008-256747 (the term “JP-A” as used herein means an “unexamined published Japanese patent application”) discloses that deterioration in quality of a display image attributable to a change in the environment of a liquid crystal display device can be suppressed by using a polarizing plate protective film in which a plurality of coat layers having low moisture permeability are formed on a transparent substrate.

In JP-A-2008-95064, it is stated that in a protective adhesive film obtained by providing an adhesive layer on a hardcoat film composed of a film substrate having a hardcoat layer, for example, a modified rosin or a polymerized rosin may be blended in the hardcoat layer so as to ensure adherence between the hardcoat layer and the film substrate.

Furthermore, JP-A-2012-201786 describes an ultraviolet-curable resin composition used for integrating a display panel and a protective plate of a display device, wherein the ultraviolet-curable resin composition contains a rosin ester-based resin as a plasticizer.

### SUMMARY OF THE INVENTION

However, a polarizing plate protective film having further higher surface hardness than the surface hardness of the coat layer of the polarizing plate protective film described in JP-A-2008-256747 and at the same time, having lower moisture permeability is demanded.

Under these circumstances, an object of the present invention, i.e., the problem that the invention is to solve, is to provide a polarizing plate protective film having low moisture permeability, high surface hardness and excellent productivity.

Another object of the present invention is to provide a polarizing plate using the polarizing plate protective film, and a liquid crystal display device using the polarizing plate, which is excellent in the image quality after aging in a high-temperature high-humidity environment.

As a result of intensive studies, the present inventors have found that the above-described object can be attained by using a polarizing plate protective film having, on a substrate film, a cured layer obtained from a curable composition containing, in a specific ratio, (A) a compound having three or more ethylenically unsaturated double bond in the molecule and (B) a rosin compound having an acid value of 150 to 400 mgKOH/g. Furthermore, it has been found that a liquid crystal display device improved in the light leakage after aging in a high-temperature high-humidity environment can be provided by using such a polarizing plate protective film. The present invention has been accomplished based on these findings.

The problem that the invention is to solve can be solved by the present invention involving the following means.

[1] A polarizing plate protective film comprising:

a substrate film, and

a layer formed by curing a curable composition containing, setting a total solid content of the curable composition to 100 mass % (also referred to as “assuming that a total solid content of the curable composition is 100 mass %”), from 50 to 90 mass % of the following (A) and from 10 to 40 mass % of the following (B) based on the total solid content:

(A) a compound having three or more ethylenically unsaturated double bonds in the molecule, and

(B) a rosin compound having an acid value of 150 to 400 mgKOH/g.

[2] The polarizing plate protective film as described in [1],

wherein the curable composition contains, as the (A), at least either one of a (meth)acrylate compound and a urethane(meth)acrylate compound.

[3] The polarizing plate protective film as described in [1] or [2],

wherein the (B) is at least one rosin compound selected from rosin, a hydrogenated rosin, and an acid-modified rosin.

[4] The polarizing plate protective film as described in any one of [1] to [3],

wherein the substrate film is a cellulose acylate film.

[5] The polarizing plate protective film as described in any one of [1] to [3],

wherein the substrate film is a (meth)acrylic polymer having, in the main chain, at least one structure of a lactone ring structure, an anhydrous glutaric acid ring structure and a glutarimide ring structure.

[6] A method for producing a polarizing plate protective film, comprising:

a step of forming, on a substrate film, a layer by curing a curable composition containing, setting a total solid content of the curable composition to 100 mass %, from 50 to 90 mass % of the following (A) and from 10 to 40 mass % of the following (B) based on the total solid content:

(A) a compound having three or more ethylenically unsaturated double bonds in the molecule, and

(B) a rosin compound having an acid value of 150 to 400 mgKOH/g.

[7] A polarizing plate comprising a polarizer and at least one sheet of the polarizing plate protective film described in any one of [1] to [5].
[8] A liquid crystal display device comprising:

a liquid crystal cell, and

the polarizing plate described in [7] disposed on at least one surface of the liquid crystal cell,

wherein the polarizing plate protective film of the polarizing plate is disposed on the outermost surface opposite the liquid crystal cell.

According to the present invention, a polarizing plate protective film having low moisture permeability, high surface hardness and excellent productivity can be provided. In addition, a polarizing plate having a polarizer and the polarizing plate protective film above and a liquid crystal display device having this polarizing plate can be provided, and in turn, a liquid crystal display device reduced in the occurrence of light leakage after aging in a high-temperature high-humidity environment can be provided.

### DETAILED DESCRIPTION OF THE INVENTION

The present invention is described in detail below.

In the following, the constitutional requirements are described based on representative embodiments of the present invention, but the present invention is not limited to these embodiments. Incidentally, in the description of the present invention, the numerical range expressed using “to” denotes a range including numerical values before and after “to” as a lower limit value and an upper limit value, respectively.

The “acrylic resin” means a resin obtained by polymerizing a derivative of methacrylic acid or acrylic acid, or a resin containing the derivative. In addition, unless otherwise limited, the “(meth)acrylate” indicates at least either acrylate or methacrylate, and the “(meth)acryl” indicates at least either acryl or methacryl.

Furthermore, the “slow axis direction” of the film means a direction where the refractive index becomes maximum in the film plane, and the “fast axis direction” means a direction orthogonal to the slow axis in the film plane.

### [Polarizing Plate Protective Film]

The polarizing plate protective film of the present invention is a polarizing plate protective film having:

a substrate film, and

a layer formed by curing a curable composition containing, assuming that a total solid content of the curable composition is 100 mass %, from 50 to 90 mass % of the following (A) and from 10 to 40 mass % of the following (B) based on the total solid content:

(A) a compound having three or more ethylenically unsaturated double bonds in the molecule, and

(B) a rosin compound having an acid value of 150 to 400 mgKOH/g.

In the polarizing plate protective film of the present invention, the layer formed by cuing a curable composition containing specific contents of (A) and (B) is a layer lower in the moisture humidity than the conventional hardcoat layer and is sometimes referred to as “low moisture-permeable layer”. In addition, the curable composition above is sometimes referred to as “low moisture-permeable layer-forming curable composition”.

### (Moisture Permeability of Polarizing Plate Protective Film)

The polarizing plate protective film of the present invention has a layer formed by curing a curable composition containing specific contents of (A) and (B), so that low moisture permeability and high surface hardness can be achieved by the synergistic effect of (A) and (B).

The polarizing plate protective film of the present invention preferably has a moisture permeability of 5.0 to 200 g/m²/day.

Here, the moisture permeability is a value after the passing of 24 hours at 40° C. and 90% relative humidity according to JIS Z-0208.

The moisture permeability of the polarizing plate protective film of the present invention is preferably 180 g/m²/day or less, more preferably 150 g/m²/day or less, still more preferably 130 g/m²/day or less. When the moisture permeability is 200 g/m²/day or less, the liquid crystal display device can be prevented from light leakage accompanying warpage of the liquid crystal cell after aging in an ordinary temperature environment, in a high-humidity environment or in a high-temperature high-humidity environment.

### {Low Moisture-Permeable Layer}

The low moisture-permeable layer in the polarizing plate protective film of the present invention is a layer formed by curing a curable composition containing, assuming that the total solid content of the curable composition is 100 mass %, from 50 to 90 mass % of (A) and from 10 to 40 mass % of (B) based on the total solid content. The low moisture-permeable layer-forming curable composition may further contain, if desired, a polymerization initiator, a light-transmitting particle, a fluorine- or silicon-containing compound, and a solvent. In addition, the substrate film and the low moisture-permeable layer may be stacked directly on each other or by the intervention of another layer therebetween.

### [(A) Compound Having Three or More Ethylenically Unsaturated Double Bonds in the Molecule]

Hereinafter, (A) above is sometimes referred to as the component (A).

The component (A) is preferably a (meth)acrylate compound, and examples thereof include (meth)acrylic acid diesters of a polyhydric alcohol, (meth)acrylic acid diesters of an ethylene oxide or propylene oxide adduct, epoxy(meth)acrylates, urethane(meth)acrylates, and polyester(meth)acrylates.

Specific compounds of the trifunctional or higher polyfunctional acrylate-based compounds include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, polyurethane polyacrylate, polyester polyacrylate, caprolactone-modified tris(acryloxyethyl)isocyanurate, etc.

Other than those described above, specific compounds include an esterification product of a polyol and a (meth)acrylic acid, such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60 and KAYARAD GPO-303 produced by Nippon Kayaku Co., Ltd. and V#3PA, V#400, V#36095D, V#1000 and V#1080 produced by Osaka Organic Chemical Industry Ltd.

The trifunctional or higher functional urethane acrylate compound includes Shiko UV-1400B, Shiko LTV-1700B, Shiko UV-6300B, Shiko UV-7550B, Shiko UV-7600B, Shiko UV-7605B, Shiko UV-7610B, Shiko UV-7620EA, Shiko UV-7630B, Shiko UV-7640B, Shiko UV-6630B, Shiko UV-7000B, Shiko UV-7510B, Shiko UV-7461TE, Shiko UV-3000B, Shiko UV-3200B, Shiko UV-3210EA, Shiko UV-3310EA, Shiko UV-3310B, Shiko UV-3500BA, Shiko UV-3520TL, Shiko UV-3700B, Shiko UV-6100B, Shiko UV-6640B, Shiko UV-2000B, Shiko UV-2010B, Shiko UV-2250EA, Shiko UV-2750B (produced by The Nippon Synthetic Chemical Industry Co., Ltd.), UA-306H, UA-306T, UA-306I, UA-510H (produced by Kyoeisha Chemical Co., Ltd.), Unidic 17-806, Unidic 17-813, Unidic V-4030, Unidic V-4000BA (produced by Dainippon Ink and Chemicals, Inc.), EB-1290K, EB-220, EB-5129, EB-1830, EB-4858 (produced by Daicel-UCB Company Ltd.), HI-Coap AU-2010, HI-Coap AU-2020 (produced by Tokushiki Co., Ltd.), ARONIX M-1960 (produced by Toagosei Co., Ltd.), Artresin UN-3320HA, UN-3320HC, UN-3320HS, UN-904, HDP-4T, etc.

As the trifunctional or higher functional polyester(meth)acrylate compound, ARONIX M-8100, M-8030, M-9050 (produced by TOAGOSEI Co., Ltd.), KRM-8307 (produced by Daicel-Cytec Co., Ltd.), etc. may also be suitably used.

Among these, at least one compound of (meth)acrylate compounds and urethane(meth)acrylate compounds is preferably used as the component (A).

[(B) Rosin Compound Having an Acid Value of 150 to 400 mgKOH/g]

Hereinafter, (B) above is sometimes referred to as the component (B).

The component (B) is contained in the low moisture-permeable layer-forming curable composition, whereby moisture permeability can be more lowered.

From the standpoint of achieving both the moisture permeability-reducing effect and the high pencil hardness, the acid value of the component (B) is from 150 to 400 mgKOH/g, preferably from 200 to 400 mgKOH/g, more preferably from 280 to 400 mgKOH/g, still more preferably from 320 to 400 mgKOH/g.

The acid value of the component (B) is a value measured in conformity with the method of JIS K5601-2-1.

The component (B) is preferably one or more members selected from rosin, a hydrogenated rosin (sometimes referred to as rosin hydride), and an acid-modified rosin.

The rosin includes an unmodified rosin, such as tall oil rosin, gum rosin and wood rosin, containing, as the main component, a resin acid such as abietic acid, levopimaric acid, palustric acid, neoabietic acid, dehydroabietic acid or dihydroabietic acid.

The hydrogenated rosin indicates a rosin obtained by hydrogenating the rosin above and includes, for example, those containing a high content (for example, 50 mass % or more) of a tetrahydro form such as tetrahydroabietic acid.

The acid-modified rosin includes an unsaturated acid-modified rosin in which an unsaturated acid such as maleic acid, fumaric acid and acrylic acid is added by a Diels-Alder addition reaction, and more specifically, the acid-modified rosin includes, for example, a maleopimaric acid in which maleic acid is added to rosin, a fumaropimaric acid in which fumaric acid is added, and an acrylopimaric acid in which an acrylic acid is added. The esterified rosin includes, for example, an alkyl ester of rosin, a glycerin ester obtained by an esterification reaction of rosin and glycerin, and a pentaerythritol ester obtained by esterifying rosin and pentaerythritol.

Other than those described above, the component (B) includes Pinecrystal KR-85 (acid value: 165 to 175 mgKOH/g, softening point: 80 to 87° C.), Pinecrystal KR-120 (acid value: about 320 mgKOH/g, softening point: about 120° C.), Pinecrystal KR-140 (acid value: 130 to 160, softening point: 130 to 150° C.), Pinecrystal KR-612 (acid value: 165 to 175, softening point: 80 to 90° C.), Pinecrystal KR-614 (acid value: 170 to 180, softening point: 84 to 94° C.), Pinecrystal KE-604 (acid value: 230 to 245, softening point: 124 to 134° C.) (all, trade names, ultralight color-based rosin derivatives, produced by Arakawa Chemical Industries, Ltd.), Aradime R-95 (acid value: 158 to 168, softening point: 93 to 103° C.) (trade name, polymerized rosin, produced by Arakawa Chemical Industries, Ltd.), Hypale CH (acid value: 145 or more, softening point: 65° C. or more) (trade name, hydrogenated rosin, produced by Arakawa Chemical Industries, Ltd.), etc.

As the component (B), a compound subjected to acid modification and then to hydrogenation treatment is preferably used. By applying a hydrogenation treatment, the remaining double bond of the rosin compound can be prevented from being oxidized in a low moisture-permeable layer to cause coloring of the film.

The softening point of the rosin compound is preferably from 70 to 170° C. When the softening point of the rosin compound is 70° C. or more, the cured layer is not softened and exerts an excellent blocking property. When the softening point is less than 170° C., the solubility for a solvent can be maintained, and this is advantageous in that the haze of the cured layer is less likely to increase.

In the present invention, the softening point of the rosin compound can be measured by the ring-and-ball method of JIS K-2531.

In view of pronounced reduction of the moisture permeability, the content of the component (B) is from 10 to 40 mass % based on the total solid content of the low moisture-permeable layer-forming curable composition, assuming that the total solid content is 100 mass %. The content of the component (B) is preferably from 10 to 35 mass %, more preferably from 10 to 30 mass %, still more preferably from 10 to 25 mass %, based on the total solid content. (In this specification, mass ratio is equal to weight ratio.)

### [Light-Transmitting Particle]

In the present invention, a light-transmitting particle may be incorporated into the low moisture-permeable layer.

By incorporating a light-transmitting particle into the low moisture-permeable layer, an concavoconvex shape may be afforded to the low moisture-permeable layer surface or internal haze may be imparted.

The light-transmitting particle that can be used in the low moisture-permeable layer includes, for example, a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), a benzoguanamine-melamine formaldehyde particle (refractive index: 1.68), a silica particle (refractive index: 1.46), an alumina particle (refractive index: 1.63), a zirconia particle, a titania particle, and a particle having a hollow or a pore.

Among these, a crosslinked poly((meth)acrylate) particle and a crosslinked poly(acryl-styrene) particle are preferably used, and by adjusting the refractive index of the binder according to the refractive index of each light-transmitting particle selected from these particles, the surface unevenness, surface haze, internal haze and total haze, which are suitable for the low moisture-permeable layer, can be achieved.

As the light-transmitting particle, those described in JP-A-2008-262187, JP-A-2010-079098, JP-A-2007-148398, etc. may be used.

### [Inorganic Layered Compound]

In order to more reduce the moisture permeability of the low moisture-permeable layer of the present invention, it is also preferable to disperse an inorganic layered compound in the low moisture-permeable layer.

As the inorganic layered compound, those described in JP-A-9-127313, JP-A-2009-298977, JP-A-2012-234094, etc. may be used.

### [Polymerization Initiator]

The low moisture-permeable layer-forming curable composition for use in the present invention preferably contains a polymerization initiator.

The polymerization initiator is preferably a photopolymerization initiator.

The photopolymerization initiator includes acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, coumarins, etc. Specific examples, preferred embodiments, commercially available products and the like of the photopolymerization initiator are described in paragraphs [0133] to [0151] of JP-A-2009-098658, and these may be suitably used likewise in the present invention.

The content of the photopolymerization initiator in the low moisture-permeable layer-forming curable composition is preferably from 0.5 to 8 mass %, more preferably from 1 to 5 mass %, based on the total solid content in the low moisture-permeable layer-forming curable composition, for the reason that the content is set to polymerize a polymerizable compound contained in the low moisture-permeable layer-forming curable composition and prevent an excessive increase of the initiation site.

### [Ultraviolet Absorber]

The polarizing plate protective film of the present invention containing a low moisture-permeable layer can be used for a polarizing plate or a liquid crystal display device member, and from the standpoint of preventing deterioration of a polarizing plate, a liquid crystal cell, etc., ultraviolet absorptivity may also be imparted to the polarizing plate protective film by incorporating an ultraviolet absorber into the low moisture-permeable layer.

As the ultraviolet absorber, a known ultraviolet absorber may be used, and examples thereof include ultraviolet absorbers described in JP-A-2001-72782 and JP-T-2002-543265 (the term “JP-T” as used herein means a published Japanese translation of a PCT patent application).

### [Solvent]

The low moisture-permeable layer-forming curable composition may contain a solvent.

As the solvent, various solvents may be used by taking into account the solubility of monomer, the drying property during coating, the dispersibility of light-transmitting particle, and the like. Such an organic solvent includes, for example, dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, and xylene. One of these solvents may be used alone, or two or more thereof may be used in combination.

Among the solvents above, it is preferable to use at least one kind of a solvent out of methyl acetate, ethyl acetate, methyl ethyl ketone, acetylacetone, acetone, toluene and xylene.

The solvent is preferably used such that the solid content concentration of the low moisture-permeable layer-forming curable composition becomes from 20 to 80 mass %, more preferably from 30 to 75 mass %, still more preferably from 40 to 70 mass %.

### (Configuration and Stacking Method of Low Moisture-Permeable Layer)

The low moisture-permeable layer may be one layer, or a plurality of layers may be provided. The method for stacking the low moisture-permeable layer is not particularly limited, but it is preferable to provide the low moisture-permeable layer by coating.

### (Film Thickness of Low Moisture-Permeable Layer)

The film thickness of the low moisture-permeable layer of the present invention is preferably from 0.5 to 25 μm, more preferably from 1 to 20 μm, still more preferably from 2 to 18 μm, yet still more preferably from 3 to 17

### (Moisture Permeability of Low Moisture-Permeable Layer)

In accordance with the gas permeation method of a composite film (Tsutomu Nakagawa, Hoso-zairyo no Barrier-sei no Kagaku (Hoso-gaku Kiso Koza 5) (Science of Barrier Property of Packaging Material (SPSTJ Basic Course 5)), pp. 68-72, Society of Packaging Science & Technology, Japan), the following formula holds assuming that the moisture permeability of a polarizing plate protective film in a stationary state is J_{f}, the moisture permeability of the substrate film is Jₛ, and the moisture permeability of the low moisture-permeable layer when the polarizing plate protective film is separated into the substrate film and the low moisture-permeable layer is J_{b}:

1/J_{f}=1/Jₛ+1J_{b} Formula (1)

The moisture permeability J_{f} of the polarizing plate protective film and the moisture permeability Jₛ of the substrate film can be measured directly, and based on these measured values, the moisture permeability J_{b} of the low moisture-permeable layer can be determined by calculation.

In the present invention, the moisture permeability of the low moisture-permeable layer is preferably from 5.0 to 100 g/m²/day.

### (Moisture Permeability Per Unit Film Thickness of Low Moisture-Permeable Layer)

The moisture permeability is generally known to be inversely proportional to the film thickness. Accordingly, the moisture permeability that can be achieved by the low moisture-permeable layer in the above-described film thickness range is determined by the moisture permeability per unit film thickness, which is a characteristic value of the material, and as the value thereof is smaller, a lower moisture permeability can be achieved. On the other hand, the moisture permeability can be adjusted by adjusting the film thickness of the low moisture-permeable layer based on the relationship above, but if the moisture permeability per unit film thickness is too low, the moisture permeability of the polarizing plate protective film becomes difficult to control.

In consideration of these two things, the moisture permeability of the low moisture-permeable layer per film thickness of 10 μm is preferably from 5.0 to 150 g/m²/day, more preferably from 10 to 100 g/m²/day, still more preferably from 20 to 90 g/m²/day, yet still more preferably from 30 to 80 g/m²/day.

Here, the moisture permeability is a value after the passing of 24 hours at 40° C. and 90% relative humidity according to the method of JIS Z-0208.

Incidentally, the moisture permeability of the low moisture-permeable layer per film thickness of 10 μm is estimated as follows from the moisture permeabilities of the substrate film and polarizing plate protective film and the film thickness of the low moisture-permeable layer.

The moisture permeability C_{b}(10 μm) of the low moisture-permeable layer relative to a film thickness of 10 μm can be represented by the following formula based on J_{b} calculated above:

C_{b}(10 μm)=J_{b}×d_{b}/10 [g/m²/day] Formula (2)

wherein d_{b} [μm] is the film thickness of the low moisture-permeable layer and as described above, can be determined from the difference in the film thickness between before and after stacking of the low moisture-permeable layer.

It is also preferable to impart a hardcoat function, an antireflection function, an antifouling function, etc. at the same time to the low moisture-permeable layer of the polarizing plate protective film of the present invention.

### {Substrate Film}

The material forming the substrate film is preferably a polymer excellent in the optical performance, transparency, mechanical strength, thermal stability, isotropy, etc. The transparence as used in the present invention indicates that the visible light transmittance is 60% or more, and the visible light transmittance is preferably 80% or more, more preferably 90% or more. The polymer includes, for example, a polycarbonate-based polymer, a polyester-based polymer such as polyethylene terephthalate and polyethylene naphthalate, a (meth)acrylic polymer such as polymethyl methacrylate, and a styrene-based polymer such as polystyrene and acrylonitrile-styrene copolymer (AS resin). Other examples include a polyolefin-based polymer such as polyethylene, polyolefin (e.g., polypropylene) and ethylene-propylene copolymer, a vinyl chloride-based polymer, an amide-based polymer such as nylon and aromatic polyamide, an imide-based polymer, a sulfone-based polymer, a polyethersulfone-based polymer, a polyether ether ketone-based polymer, a polyphenylene sulfide-based polymer, a vinylidene chloride-based polymer, a vinyl butyral-based polymer, an allylate-based polymer, a polyoxymethylene-based polymer, an epoxy-based polymer, and a polymer obtained by mixing the polymers above. In addition, the substrate film of the present invention may also be formed as a cured layer of an ultraviolet-curable or thermosetting resin such as acrylic, urethane-based, acrylic urethane-based, epoxy-based or silicone-based resin.

As the material forming the substrate film, a cellulose-based polymer typified by triacetyl cellulose (among others, preferably cellulose acylate), which has been conventionally employed as a transparent protective film for a polarizing plate, may also be preferably used. Furthermore, an acrylic film of which introduction as a polarizing plate protective film has been recently proposed, may also be preferably used. In the following, as an example of the substrate film of the present invention, cellulose acylate and a (meth)acrylic polymer are mainly described in detail, but the technical matters thereof can be applied likewise to other polymer films.

### <Cellulose Acylate>

As the cellulose acylate film, for example, those described in paragraphs [0072] to of JP-A-2013-228720 may be used.

### <(Meth)acrylic Polymer>

It is also preferred that the substrate film is formed of a (meth)acrylic polymer.

Here, the (meth)acrylic polymer is a concept encompassing both a methacrylic polymer and an acrylic polymer. Furthermore, the (meth)acrylic polymer encompasses an acrylate/methacrylate derivative, particularly an acrylate ester/methacrylate ester (co)polymer.

The (meth)acrylic polymer that is preferably used in the present invention contains, as a repeating structural unit, a repeating structural unit derived from a (meth)acrylic acid ester monomer and may further contain, in the main chain, at least one structure of a lactone ring structure, an anhydrous glutaric acid ring structure and a glutarimide ring structure.

The (meth)acrylic polymer may further contain, as a repeating structural unit, a repeating structural unit obtained by polymerizing at least one member selected from a hydroxyl group-containing monomer, an unsaturated carboxylic acid and a monomer represented by the following formula (201): Formula (201):

CH₂═C(X)R²⁰¹

wherein R²⁰¹ represents a hydrogen atom or a methyl group, X represents a hydrogen atom, an alkyl group having a carbon number of 1 to 20, an aryl group, a —CN group, a —CO—R²⁰² group or a —O—CO—R²⁰³ group, and each of R²⁰² and R²⁰³ independently represents a hydrogen atom or an organic residue having a carbon number of 1 to 20.

The (meth)acrylic acid ester is not particularly limited but includes, for example, an acrylic acid ester such as methyl acrylate, ethyl acrylate, n-butyl acrylate, isobutyl acrylate, tert-butyl acrylate, cyclohexyl acrylate and benzyl acrylate; and a methacrylic acid ester such as methyl methacrylate, ethyl methacrylate, propyl methacrylate, n-butyl methacrylate, isobutyl methacrylate, tert-butyl methacrylate, cyclohexyl methacrylate and benzyl methacrylate, and only one of these esters may be used, or two or more thereof may be used in combination. Among these, methyl methacrylate is preferred because of its excellent heat resistance and transparency.

In the case of using a (meth)acrylic acid ester, the content ratio thereof to the monomer components used in the polymerization process is, from the standpoint of sufficiently bringing out the effects of the present invention, preferably from 10 to 100 mass %, more preferably from 10 to 100 mass %, still more preferably from 40 to 100 mass %, yet still more preferably from 50 to 100 mass %.

The hydroxyl group-containing monomer includes a 2-(hydroxyalkyl)acrylic acid ester such as α-hydroxymethylstyrene, α-hydroxyethylstyrene and methyl 2-(hydroxyethyl)acrylate; a 2-(hydroxyalkyl)acrylic acid such as 2-(hydroxyethyl)acrylic acid; etc., and only one of these monomers may be used, or two or more thereof may be used in combination.

In the case of using a hydroxyl group-containing monomer, the content ratio thereof to the monomer components used in the polymerization process is, from the standpoint of sufficiently bringing out the effects of the present invention, preferably from 0 to 30 mass %, more preferably from 0 to 20 mass %, still more preferably from 0 to 15 mass %, yet still more preferably from 0 to 10 mass %.

The unsaturated carboxylic acid includes, for example, an acrylic acid, a methacrylic acid, a crotonic acid, an α-substituted acrylic acid, and an α-substituted methacrylic acid, and only one of these acids may be used, or two or more thereof may be used in combination. Among these, an acrylic acid and a methacrylic acid are preferred for the purpose of sufficiently bringing out the effects of the present invention.

In the case of using an unsaturated carboxylic acid, the content ratio thereof to the monomer components used in the polymerization process is, from the standpoint of sufficiently bringing out the effects of the present invention, preferably from 0 to 30 mass %, more preferably from 0 to 20 mass %, still more preferably from 0 to 15 mass %, yet still more preferably from 0 to 10 mass %.

The monomer represented by formula (201) includes, for example, styrene, vinyltoluene, α-methylstyrene, acrylonitrile, methyl vinyl ketone, ethylene, propylene, and vinyl acetate, and only one of these monomers may be used, or two or more thereof may be used in combination. Among these, styrene and α-methylstyrene are preferred for the purpose of sufficiently bringing out the effects of the present invention.

In the case of using a monomer represented by formula (201), the content ratio thereof to the monomer components used in the polymerization process is, from the standpoint of sufficiently bringing out the effects of the present invention, preferably from 0 to 30 mass %, more preferably from 0 to 20 mass %, still more preferably from 0 to 15 mass %, yet still more preferably from 0 to 10 mass %.

### [(Meth)Acrylic Polymer Having a Ring Structure in the Main Chain]

Among the (meth)acrylic polymers, a polymer having a ring structure in the main chain is preferred. By introducing a ring structure into the main chain, the rigidity of the main chain can be increased, and the heat resistance can be improved.

Among the (meth)acrylic polymers having a ring structure in the main chain, the polymer is preferably any one of a polymer having a lactone ring structure in the main chain, a polymer having an anhydrous glutaric acid ring structure in the main chain, and a polymer having a glutarimide ring structure in the main chain. Above all, a polymer having formed in the main chain thereof a lactone ring structure is more preferred.

These polymers having a ring structure in the main chain are described in sequence.

### ((Meth)Acrylic Polymer Having a Lactone Ring Structure in the Main Chain)

The (meth)acrylic polymer having a lactone ring structure in the main chain (hereinafter, sometimes referred to as lactone ring-containing polymer) is a (meth)acrylic polymer having a lactone ring in the main chain, and the resins described in JP-A-2006-096960, JP-A-2007-063541, etc. may be used.

### (Polymer Having an Anhydrous Glutaric Acid Ring Structure in the Main Chain)

The polymer having an anhydrous glutaric acid ring structure in the main chain is a polymer having a glutaric anhydride unit, and the resins described in JP-A-2009-210905, JP-A-2009-030001, etc. may be used.

### ((Meth)Acrylic Polymer Having a Glutarimide Ring Structure in the Main Chain)

The (meth)acrylic polymer having a glutarimide ring structure in the main chain (hereinafter, sometimes referred to as glutarimide-based resin) has a glutarimide ring structure in the main chain and thereby can bring about a preferred characteristic balance in terms of optical properties, heat resistance, etc.

The glutarimide-based resin is described, for example, in U.S. Pat. Nos. 3,284,425 and 4,246,374 and JP-A-2-153904 and can be obtained by a method where a resin produced using a methacrylic acid methylester, etc. as the main raw material is employed as a resin having an imidizable unit and the resin having an imidizable unit is imidized using ammonia or a substituted amine.

### <Ultraviolet Absorber>

The substrate film may contain an ultraviolet absorber.

The ultraviolet absorber preferably used in the substrate film is described. The polarizing plate protective film of the present invention including a substrate film may be used for a polarizing plate, a liquid crystal display member, etc. and from the standpoint of preventing deterioration of the polarizing plate, the liquid crystal cell, etc., an ultraviolet absorber is preferably used. An ultraviolet absorber having an excellent ability of absorbing an ultraviolet ray at a wavelength of 370 nm or less and, in view of good liquid crystal display property, having little absorption of visible light at a wavelength of 400 nm or more is preferably used. Only one ultraviolet absorber may be used, or two or more ultraviolet absorbers may be used in combination. The ultraviolet absorber, includes, for example, the ultraviolet absorbers described in JP-A-2001-72782 and JP-T-2002-543265. Specific examples of the ultraviolet absorber include an oxybenzophenone-based compound, a benzotriazole-based compound, a salicylic acid ester-based compound, a benzophenone-based compound, a cyanoacrylate-based compound, and a nickel complex salt-based compound.

### (Other Additives)

In the substrate film, additives such as matting agent, rubbery particle, retardation developer, plasticizer, deterioration inhibitor, release agent, infrared absorber and wavelength dispersion adjuster may be added, and these additives may be a solid or an oily matter. That is, the additive is not particularly limited in its melting point or boiling point. For example, mixing of an ultraviolet absorbing material with a melting or boiling point of 20° C. or less and an ultraviolet absorbing material with a melting or boiling point of 20° C. or more, or mixing of plasticizers combined likewise may be employed, and this is described, for example, in JP-A-2001-151901. Furthermore, infrared absorbing dyes are described, for example, in JP-A-2001-194522. As for the timing of addition, the additive may be added at any time in the dope producing process, or a step of adding the additive and preparing a dope may be added as a final preparation step in the dope preparation process. The amount of the material added is not particularly limited as long as its function is exerted. Also, in the case where the polarizing plate protective film is formed by multiple layers, the kind and amount added of the additive may differ among respective layers, and this is described, for example, in JPA-2001-151902. Details thereof are described in JIII Journal of Technical Disclosure (Journal of Technical Disclosure No. 2001-1745, Mar. 15, 2001, Japan Institute of Invention and Innovation), pp. 16-22, and the materials described in detail therein are preferably used.

### <Properties of Substrate Film>

### (Thickness of Substrate Film)

The thickness of the substrate film is preferably from 5 to 100 μm, more preferably from 10 to 80 μm, still more preferably from 15 to 70 μm, yet still more preferably from 20 to 60 μm. By controlling the film thickness to fall in the range above, panel unevenness accompanying a change in the environment where a liquid crystal display device is placed after stacking the low moisture-permeable layer, that is, a change in the temperature and humidity, can be reduced.

### (Surface Treatment)

Depending on the case, the substrate film may be subjected to a surface treatment so that the adhesion of the substrate film to the low moisture-permeable layer can be enhanced. For example, a glow discharge treatment, an ultraviolet irradiation treatment, a corona treatment, a flame treatment, and an acid or alkali treatment may be employed. The glow discharge treatment as used herein may be a treatment with low-temperature plasma occurring in a low-pressure gas of 1.33×10⁻¹ to 2.67×10³ Pa, and furthermore, a plasma treatment under atmospheric pressure is also preferred. The plasma-exciting gas indicates a gas that is excited into plasma under the above-described conditions, and includes, for example, argon, helium, neon, krypton, xenon, nitrogen, carbon dioxide, fluorocarbons such as tetrafluoromethane, and a mixture thereof. Details thereof are described in JIII Journal of Technical Disclosure (Journal of Technical Disclosure No. 2001-1745, Mar. 15, 2001, Japan Institute of Invention and Innovation), pp. 30-32, and those described therein can be preferably used in the present invention.

### (Thickness of Polarizing Plate Protective Film)

The thickness of the polarizing plate protective film of the present invention is preferably from 5 to 100 μm, more preferably from 10 to 80 μm, still more preferably from 25 to 75 μm.

### [Layer Configuration of Polarizing Plate Protective Film]

The polarizing plate protective film of the present invention is a laminate having a low moisture-permeable layer on one surface of the substrate film, and the substrate film may be put into direct contact with the low moisture-permeable layer, or other layers may intervene between the substrate film and the low moisture-permeable layer.

### {Functional Layer}

In the present invention, the polarizing plate protective film may further have a functional layer as a layer other than the low moisture-permeable layer. The functional layer includes an antireflection layer (a layer where the refractive index is adjusted, such as low refractive index layer, medium refractive index layer and high refractive index layer), an antiglare layer, an antistatic layer, an ultraviolet absorbing layer, an adherence layer (a layer for enhancing the adherence between the substrate film and the low moisture-permeable layer), etc.

One functional layer may be provided, or a plurality of functional layers may be provided. The method for stacking the functional layer is not particularly limited.

The production method of a polarizing plate protective film of the present invention is a method for producing a polarizing plate protective film, involving a step of forming, on a substrate film, a layer by curing a curable composition containing, assuming that a total solid content of the curable composition is 100 mass %, from 50 to 90 mass % of the following (A) and from 10 to 40 mass % of the following (B) based on the total solid content:

(A) a compound having three or more ethylenically unsaturated double bonds in the molecule, and

(B) a rosin compound having an acid value of 150 to 400 mgKOH/g.

In the production method of a polarizing plate protective film of the present invention, it is preferred that a low moisture-permeable layer-forming curable composition is coated on a substrate film and the coating film is irradiated with light and thereby cured.

The method for coating the low moisture-permeable layer-forming curable composition is not particularly limited, and a known method may be used. Examples thereof include a dip coating method, an air-knife coating method, a curtain coating method, a roller coating method, a wire bar coating method, a gravure coating method, and a die coating method.

### [Polarizing Plate]

The polarizing plate of the present invention has a polarizer and at least one sheet of the polarizing plate protective film of the present invention.

In the present invention, the method for manufacturing the polarizing plate is not particularly limited, and the polarizing plate can be manufactured by a general method. There is a method where the obtained polarizing plate protective film is alkali-treated and laminated to both surfaces of a polarizer produced by dipping a polyvinyl alcohol film in an iodine solution and stretching the film, with use of an aqueous completely saponified polyvinyl alcohol solution. In place of an alkali treatment, an easy adhesion processing described in JP-A-6-94915 and JP-A-6-118232 may be applied. Alternatively, the above-described surface treatment may be performed. The polarizing plate protective film surface laminated to the polarizer may be the surface where the low moisture-permeable layer of the present invention is stacked, or a surface where the low moisture-permeable layer is not stacked.

### [Liquid Crystal Display Device]

The liquid crystal display device of the present invention includes a liquid crystal cell and the polarizing plate of the present invention disposed on at least one side of the liquid crystal cell and is characterized by disposing the polarizing plate such that the polarizing plate protective film of the present invention contained in the polarizing plate becomes an outermost surface layer.

### (Configuration of General Liquid Crystal Display Device)

A liquid crystal display device has a configuration consisting of a liquid crystal cell carrying a liquid crystal between two electrode substrates and two polarizing plates disposed on both sides thereof, where, if desired, at least one optically compensatory film is disposed between the liquid crystal cell and the polarizing plate.

The liquid crystal layer of the liquid crystal cell is usually formed by encapsulating a liquid crystal in a space formed by interposing a spacer between two substrates. A transparent electrode layer is formed, on a substrate, as a transparent film containing an electrically conductive substance. In the liquid crystal cell, a gas barrier layer, a hardcoat layer or an undercoat layer (subbing layer) (used for adhesion of the transparent electrode layer) may be further provided. Such a layer is usually provided on the substrate. The substrate of the liquid crystal cell generally has a thickness of 50 μm to 2 mm.

In a liquid crystal display device, a substrate including a liquid crystal cell is usually disposed between two polarizing plates. The polarizing plate protective film of the present invention may be used as a protective film for either one of two polarizing plates but is preferably used, out of two protective films of respective polarizing plates, as a protective film disposed outside of the liquid crystal cell relative to the polarizer.

In particular, the polarizing plate protective film of the present invention is preferably disposed as a viewing-side protective film of a viewing-side polarizing plate out of two polarizing plates.

It is also a preferred embodiment that after the polarizing plate protective film of the present invention is disposed as a viewing-side protective film of a viewing-side polarizing plate out of two polarizing plates, the polarizing plate protective film of the present invention is further disposed as a backlight-side protective film of a backlight-side polarizing plate to thereby restrain the shrinkage of the polarizer contained in two polarizing plates and prevent the warpage of the panel.

### (Type of Liquid Crystal Display Device)

The polarizing plate protective film of the present invention can be used in liquid crystal cells of various modes. Various display modes, such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), ECB (Electrically Controlled Birefringence) and HAN (Hybrid Aligned Nematic), have been proposed. In addition, a display mode obtained by alignment division of the display mode above has also been proposed. The polarizing plate protective film of the present invention is effective in a liquid crystal display device of any display mode and is also effective in a liquid crystal display device of any of a transmission type, a reflection type and a transflective type.

### EXAMPLES

The present invention is specifically described based on Examples. The materials, reagents, amounts and ratios of substances, operations, etc. described in the following Examples can be appropriately changed without departing from the purport of the present invention. Accordingly, the present invention is not limited to these Examples.

### Production Example 1

### Production of Purified Rosin R

Into a sealable reaction vessel equipped with a stirrer, a reflux condenser and a nitrogen introducing tube, 3,000 g of an unpurified gum rosin made in China (acid value: 171 mgKOH/g, softening point: 74° C., color tone: 6G) was charged. By performing distillation under reduced pressure of 400 Pa and nitrogen purging, the main distillate (yield: 86.3%) having an acid value of 176 mgKOH/g, a softening point of 80.5° C., and a Gardener color of 2 was obtained as Purified Gum Rosin R. The acid value of the resin is a value measured in conformity with the method of JIS K-5601-2-1, and the softening point is a value measured by the ring-and-ball method of JIS K-5902-5-3.

### (Production of Unsaturated Acid-Modified Rosin A)

1,000 Parts by weight of Purified Gum Rosin R prepared above was charged into a reaction vessel equipped with a stirrer, a water separator-attached reflux condenser and a thermometer and melted by raising the temperature to 180° C. with stirring in a nitrogen atmosphere, and subsequently, 267 parts by mass of fumaric acid was charged. The resulting resin was kept warm for 1 hour by raising the temperature to 230° C. with stirring and then cooled to obtain a solid resin of Unsaturated Acid-Modified Rosin A. The acid value of the resin was 342 mgKOH/g, and the softening point was 125° C.

### (Production of Unsaturated Acid-Modified Rosin B)

A maleic acid-modified rosin was synthesized by referring to Preparation Example 3 of JP-A-2007-111735 and using Purified Gum Rosin R and a maleic acid. The acid value of the resin was 315 mgKOH/g, and the softening point was 155° C.

### (Production of Unsaturated Acid-Modified Rosin C)

An acrylic acid-modified rosin was synthesized by referring to Preparation Example 2 of JP-A-2007-111735 and using Purified Gum Rosin R and an acrylic acid. The acid value of the resin was 241 mgKOH/g, and the softening point was 130° C.

### [Preparation of Low Moisture-Permeable Layer-Forming Composition]

A low moisture-permeable layer-forming composition was prepared as follows.

### (Formulation of Low Moisture-Permeable Layer-Forming Composition BL-1)

| | |
|---|---|
| A-DPH | 77.0 parts by mass |
| Unsaturated Acid-Modified Rosin A | 20.0 parts by mass |
| Irgacure 907 | 3.0 parts by mass |
| SP-13 | 0.04 parts by mass |
| MEK (methyl ethyl ketone) | 36.7 parts by mass |
| MIBK (methyl isobutyl ketone) | 85.6 parts by mass |

Low Moisture-Permeable Layer-Forming Compositions BL-2 to BL-14 were prepared in the same manner as Low Moisture-Permeable Layer-Forming Composition BL-1. The ratio in each composition is shown in Table 1. In Table 1, the content ratio by mass in terms of solid content of respective components is shown. The solid content as used herein means a composition excluding the solvent (in BL-1, methyl ethyl ketone and methyl isobutyl ketone). In the Table below, the unit of all numerical values in the formulation is parts by mass.

The materials used are as follows.

A-DPH: A mixture of dipentaerythritol hexaacrylate and dipentaerythritol pentaacrylate [produced by Shin-Nakamura Chemical Co., Ltd.]
UA-306H: A mixture of 70 mass % of pentaerythritol triacrylate hexamethylene diisocyanate urethane prepolymer and 30 mass % of pentaerythritol tetraacrylate [produced by Kyoeisha Chemical Co., Ltd.]
UA-306T: A mixture of 70 mass % of pentaerythritol triacrylate toluene diisocyanate urethane prepolymer and 30 mass % of pentaerythritol tetraacrylate [produced by Kyoeisha Chemical Co., Ltd.]
UA-306I: A mixture of 70 mass % of pentaerythritol triacrylate isophorone diisocyanate urethane prepolymer and 30 mass % of pentaerythritol tetraacrylate [produced by Kyoeisha Chemical Co., Ltd.]
U-4HA: Tetrafunctional urethane(meth)acrylate having the following structure [produced by Shin-Nakamura Chemical Co., Ltd.]

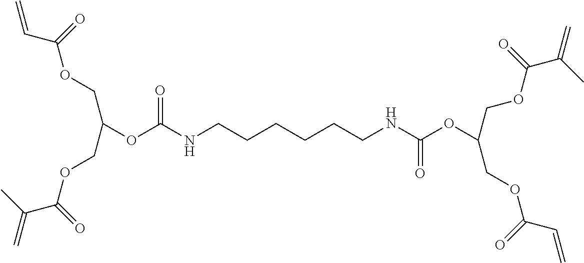 [SMILES: C=CC(=O)OCC(COC(=O)C(=C)C)OC(=O)NCCCCCCNC(=O)OC(COC(=O)C=C)COC(=O)C(=C)C]

A-200: Polyethylene glycol diacrylate having the following structure [produced by Shin-Nakamura Chemical Co., Ltd.]

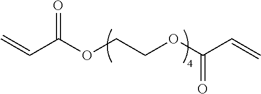

Irgacure 907: Polymerization initiator [produced by BASF]
SP-13 (a leveling agent having the following structure; in the structure, the compositional ratio of 60:40 is the molar ratio)

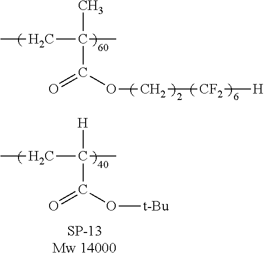

### <Production of Polarizing Plate Protective Film 101>

A roll of FUJITAC TD60 (produced by Fujifilm Corp., width: 1,340 mm, thickness: 60 μm) was unrolled as a substrate film, and Low Moisture-Permeable Layer-Forming Composition BL-1 was coated thereon by a die coating method using a slot die described in Example 1 of JP-A-2006-122889 under the condition of a conveying speed of 30 m/min and dried at 60° C. for 150 seconds. Thereafter, the coated layer was cured through irradiation with an ultraviolet ray at an illuminance of 400 mW/cm² and an irradiation dose of 350 mJ/cm² by using an air-cooled metal halide lamp (manufactured by Eye Graphics Co., Ltd.) with an output of 160 W/cm under nitrogen purging to an oxygen concentration of about 0.1 vol % to form a low moisture-permeable layer, and the film was rolled up. The coating amount was adjusted such that the film thickness of the low moisture-permeable layer becomes 15 μm. In this way, Polarizing Plate Protective Film 101 having a low moisture-permeable layer formed of Low Moisture-Permeable Layer-Forming Composition BL-1 was obtained.

### <Production of Polarizing Plate Protective Films 102 to 114>

Polarizing Plate Protective Films 102 to 114 were produced in the same manner except that in the production of Polarizing Plate Protective Film 101, Low Moisture-Permeable Layer-Forming Composition BL-1 was replaced by BL-2 to BL-14.

### [Evaluation of Polarizing Plate Protective Film]

With regard to the polarizing plate protective films produced in Examples and Comparative Examples, the film thickness was measured, and measurement and evaluation of the following physical properties were performed. The results are shown in Table 1 below.

### (1) Moisture Permeability (Moisture Permeability at 40° C. And 90% Relative Humidity)

Each of the polarizing plate protective film samples of Examples and Comparative Examples was cut into a circular form having a diameter of 70 mm and after moisture conditioning at 40° C. and 90% relative humidity for 24 hours, measured by the method of JIS Z-0208.

### (2) Pencil Hardness

The pencil hardness evaluation described in JIS K-5600-5-4 was performed as an indicator of scratch resistance. The polarizing plate protective film was moisture-conditioned at a temperature of 25° C. and a humidity of 60% RH for 2 hours and then evaluated for the pencil hardness at n=5 by using test pencils of H to 3H specified in JIS S-6006 and applying a load of 4.9N to the low moisture-permeable layer-laminated surface. The evaluation was performed according to the following criteria. Out of test pencils with which the evaluation resulted in OK, the highest pencil hardness was taken as the evaluation value.

OK: In evaluation of n=5, the number of tests with no scratch is 3 or more.

NG: In evaluation of n=5, the number of tests with no scratch is 2 or less.

TABLE 1

| | | Example/Comparative Example | | | | | | | |
|---|---|---|---|---|---|---|---|---|---|
| | | Example | Example | Example | Example | Example | Example | Example | Example |
| | | Optical film sample No. | | | | | | | |
| | | 101 | 102 | 103 | 104 | 105 | 106 | 107 | 108 |
| | | Low moisture-permeable layer-forming composition | | | | | | | |
| | | BL-1 | BL-2 | BL-3 | BL-4 | BL-5 | BL-6 | BL-7 | BL-8 |
| Acrylate | A-DPH | 77.0 | | | | | | | |
| compound | UA-306H | | 77.0 | | | | 87.0 | 67.0 | 57.0 |
| | UA-306I | | | 77.0 | | | | | |
| | UA-306T | | | | 77.0 | | | | |
| | U-4HA | | | | | 77.0 | | | |
| | A-200 | | | | | | | | |
| Compound B | Unsaturated Acid- | 20.0 | 20.0 | 20.0 | 20.0 | 20.0 | 10.0 | 30.0 | 40.0 |
| | Modified Rosin A | | | | | | | | |
| Others | Irgacure 907 | 3.0 | 3.0 | 3.0 | 3.0 | 3.0 | 3.0 | 3.0 | 3.0 |
| | SP-13 | 0.04 | 0.04 | 0.04 | 0.04 | 0.04 | 0.04 | 0.04 | 0.04 |
| | Tri- or higher functional | 77.0 | 77.0 | 77.0 | 77.0 | 77.0 | 87.0 | 67.0 | 57.0 |
| | (meth)acrylate | | | | | | | | |
| | Tri- or higher functional | | 53.9 | 53.9 | 53.9 | 77.0 | 60.9 | 46.9 | 39.9 |
| | urethane (meth)acrylate | | | | | | | | |
| Evaluation | Moisture permeability of | 110 | 79 | 81 | 78 | 74 | 103 | 78 | 77 |
| results | optical film (g/m² · day) | | | | | | | | |
| | Pencil hardness | 3H | 3H | 3H | 3H | 3H | 3H | 2H | 2H |

| | | Example/Comparative Example | | | | | |
|---|---|---|---|---|---|---|---|
| | | | | Comparative | Comparative | Comparative | Comparative |
| | | Example | Example | Example | Example | Example | Example |
| | | Optical film sample No. | | | | | |
| | | 109 | 110 | 111 | 112 | 113 | 114 |
| | | Low moisture-permeable layer-forming composition | | | | | |
| | | BL-9 | BL-10 | BL-11 | BL-12 | BL-13 | BL-14 |
| Acrylate | A-DPH | | | 97.0 | | | 92.0 |
| compound | UA-306H | | | | 52.0 | | |
| | UA-306I | 87.0 | 57.0 | | | | |
| | UA-306T | | | | | | |
| | U-4HA | | | | | | |
| | A-200 | | | | | 77.0 | |
| Compound B | Unsaturated Acid- | 10.0 | 40.0 | | 45.0 | 20.0 | 5.0 |
| | Modified Rosin A | | | | | | |
| Others | Irgacure 907 | 3.0 | 3.0 | 3.0 | 3.0 | 3.0 | 3.0 |
| | SP-13 | 0.04 | 0.04 | 0.04 | 0.04 | 0.04 | 0.04 |
| | Tri- or higher functional | 87.0 | 57.0 | 97.0 | 52.0 | 77.0 | 92.0 |
| | (meth)acrylate | | | | | | |
| | Tri- or higher functional | 60.9 | 39.9 | | 36.4 | | |
| | urethane (meth)acrylate | | | | | | |
| Evaluation | Moisture permeability of | 102 | 77 | 144 | 78 | 161 | 137 |
| results | optical film (g/m² · day) | | | | | | |
| | Pencil hardness | 2H | 2H | 3H | H | H | 3H |

The results in Table 1 reveal the followings.

1. The polarizing plate protective films of Examples having a low moisture-permeable layer formed by curing a curable composition containing a specific amount of (A) a compound having three or more ethylenically unsaturated double bonds in the molecular and a specific amount of (B) a rosin compound having an acid value of 150 to 400 mgKOH/g have low moisture permeability and high pencil hardness and are excellent.

2. In particular, those containing a urethane acrylate in a part of the component (A) have low moisture permeability and high pencil hardness and are more excellent than those not containing the urethane acrylate.

Next, a more preferred embodiment of the present invention is described by referring to examples where the kind of the (B) rosin compound having an acid value of 150 to 400 mgKOH/g is changed.

### [Preparation of Low Moisture-Permeable Layer-Forming Composition]

Low Moisture-Permeable Layer-Forming Compositions BL-21 to BL-14 were prepared in the same manner as Low Moisture-Permeable Layer-Forming Composition BL-1. The ratio in each composition is shown in Table 2. BL-21 has the same formation as BL-2.

The materials used are as follows. Those described above are omitted.

Pinecrystal KE604: Acid-modified ultralight color rosin, acid value: 235 mgKOH/g,
softening point: 129° C. [produced by Arakawa Chemical Industries, Ltd.]
Pinecrystal KR614: Ultralight color rosin, acid value: 175 mgKOH/g, softening point: 88° C. [produced by Arakawa Chemical Industries, Ltd.]
Pinecrystal KE311: Ultralight color rosin ester, acid value: 6 mgKOH/g, softening point: 95° C. [produced by Arakawa Chemical Industries, Ltd.]

### <Production of Polarizing Plate Protective Films 201 to 206>

Polarizing Plate Protective Films 201 to 206 were produced in the same manner except that in the production of Polarizing Plate Protective Film 101, Low Moisture-Permeable Layer-Forming Composition BL-21 was replaced by BL-2 to BL-26.

### [Evaluation of Polarizing Plate Protective Film]

Polarizing Plate Protective Films 201 to 206 produced were evaluated in the same manner as Polarizing Plate Protective Film 101. The results are shown in Table 2 below.

TABLE 2

| | | Example/Comparative Example | | | | | |
|---|---|---|---|---|---|---|---|
| | | | | | | | Comparative |
| | | Example | Example | Example | Example | Example | Example |
| | | Optical film sample No. | | | | | |
| | | 201 | 202 | 203 | 204 | 205 | 206 |
| | | Low moisture- | | | | | |
| | | permeable layer- | | | | | |
| | | forming composition | | | | | |
| | | BL-21 | BL-22 | BL-23 | BL-24 | BL-25 | BL-26 |
| Compound A | UA-306H | 77.0 | 77.0 | 77.0 | 77.0 | 77.0 | 77.0 |
| Compound B | Unsaturated Acid- | 20.0 | | | | | |
| | Modified Rosin A | | | | | | |
| | Unsaturated Acid- | | 20.0 | | | | |
| | Modified Rosin B | | | | | | |
| | Unsaturated Acid- | | | 20.0 | | | |
| | Modified Rosin C | | | | | | |
| | Pinecrystal KE604 | | | | 20.0 | | |
| | Pinecrystal KR614 | | | | | 20.0 | |
| | Pinecrystal E311 | | | | | | 20.0 |
| | Irgacure 907 | 3.0 | 3.0 | 3.0 | 3.0 | 3.0 | 3.0 |
| | SP-13 | 0.04 | 0.04 | 0.04 | 0.04 | 0.04 | 0.04 |
| Evaluation | Moisture permeability | 79 | 84 | 91 | 93 | 98 | 114 |
| results | of optical film | | | | | | |
| | (g/m² · day) | | | | | | |
| | Pencil hardness | 3H | 3H | 2H | 2H | 2H | H |

The results in Table 2 reveal the followings.

1. Those using a rosin compound having an acid value of 150 mgKOH/g or more have low moisture permeability and are excellent.

2. Those using a rosin compound having an acid value of 250 mgKOH/g or more have lower moisture permeability and are more excellent.

3. Those using a rosin compound having an acid value of 280 mgKOH/g or more have still lower moisture permeability and high pencil hardness and are still more excellent.

However, in all of the rosin compounds above, the acid value is 400 mgKOH/g or less.

Examples using an acrylic film as the substrate film are described below.

### <Production of Substrate Film (A-1)>

Into a reaction kettle having an internal volume of 30 L equipped with a stirring device, a temperature sensor, a cooling tube and a nitrogen introducing tube, 8,000 g of methyl methacrylate (MMA), 2,000 g of methyl 2-(hydroxymethyl)acrylate (MHMA), and 10,000 g of toluene as a polymerization solvent were charged. While passing nitrogen therethrough, the temperature was raised to 105° C., and when reflux occurring from the temperature rise started, 10.0 g of tert-amylperoxyisononanoate as a polymerization initiator was added thereto. At the same time, a solution consisting of 20.0 g of tert-amylperoxyisononanoate and 100 g of toluene was added dropwise over 2 hours, allowing solution polymerization to proceed under reflux at about 105 to 110° C., and the reaction solution was further ripened for 4 hours. The polymerization reaction ratio was 96.6%, and the percentage content of MHMA in the obtained polymer was 20.0 mass %.

The polymerization solution obtained was added with 10 g of a stearyl phosphate/distearyl phosphate mixture (Phoslex A-18, produced by Sakai Chemical Industry Co., Ltd.) as a cyclization catalyst, and a cyclocondensation reaction was allowed to proceed under reflux at about 80 to 100° C. for 5 hours.

The obtained polymerization solution was introduced into a vent-type twin-screw extruder (φ=29.75 mm, L/D=30) having a barrel temperature of 260° C., a rotation speed of 100 rpm, a decompression degree of 13.3 to 400 hPa (from 10 to 300 mmHg), 1 rear vent and 4 fore vents at a processing rate of 2.0 kg/h in terms of the resin amount and subjected to cyclocondensation reaction and devolatilization in the extruder. After the completion of devolatilization, the heat-melted resin remaining in the extruder was discharged from the end of the extruder and pelletized by a pelletizer to obtain a transparent pellet composed of an acrylic resin having a lactone ring structure in the main chain. The weight average molecular weight of this resin was 148,000, the melt flow rate (determined in conformity with JIS K7120 at a test temperature of 240° C. under a load of 10 kg; the same in the following Production Examples) was 11.0 g/10 min, and the glass transition temperature was 130° C.

The pellet obtained and an AS resin (trade name: TOYO AS AS20, produced by Toyo Styrene Co., Ltd.) were kneaded using a single-screw extruder (φ=30 mm) at a weight ratio of pellet/AS resin=90/10 to obtain a transparent pellet having a glass transition temperature of 127° C.

The thus-produced pellet of the resin composition was melt-extruded from a coat hanger-type T-die by using a twin-screw extruder to produce a resin film having a thickness of about 160 μm.

The unstretched resin film obtained was simultaneously biaxially stretched to 2.0 times in the longitudinal direction and 2.0 times in the transverse direction to produce a transparent plastic film substrate (Substrate Film (A-1)). The thickness of the biaxially stretched film thus obtained was 40 μm, the total light transmittance was 92%, the haze was 0.3%, and the glass transition temperature was 127° C.

### <Production of Polarizing Plate Protective Films 301 and 302>

Polarizing Plate Protective Films 301 and 302 were produced in the same manner as Polarizing Plate Protective Films 101 and 102, respectively, except that in the production of Polarizing Plate Protective Films 101 and 102, the substrate film was changed from FUJITAC TD60 to Substrate Film (A−1) produced above. These polarizing plate protective films were evaluated in the same manner as Polarizing Plate Protective Film 101. The results are shown in Table 3.

TABLE 3

| | Example/Comparative Example | Example | Example |
|---|---|---|---|
| | Optical film sample No. | 301 | 302 |
| | Low moisture-permeable layer- | BL-1 | BL-2 |
| | forming composition | | |
| Substrate | | A-1 | A-1 |
| Acrylate | A-DPH | 77.0 | |
| compound | UA-306H | | 77.0 |
| Compound B | Unsaturated Acid-Modified Rosin | 20.0 | 20.0 |
| | A | | |
| Others | Irgacure 907 | 3.0 | 3.0 |
| | SP-13 | 0.04 | 0.04 |
| | Tri- or higher functional | 77.0 | 77.0 |
| | (meth)acrylate | | |
| | Tri- or higher functional urethane | | 53.9 |
| | (meth)acrylate | | |
| Evaluation | Moisture permeability of optical | 51 | 43 |
| results | film (g/m² · day) | | |
| | Pencil hardness | 3H | 3H |

The results in Table 3 reveal the followings.

1. Even when the substrate film was changed to an acrylic film, similarly to the case where cellulose acylate film is used as the substrate film, the polarizing plate protective film having a low moisture-permeable layer formed by curing a curable composition containing a specific amount of (A) a compound having three or more ethylenically unsaturated double bonds in the molecule and a specific amount of (B) a rosin compound having an acid value of 150 to 400 mgKOH/g has low moisture permeability and high pencil hardness and is excellent.

Examples employing a configuration having an optically anisotropic layer formed through alignment of a polymerizable liquid crystal compound and curing are described below.

### <Production of Transparent Support (Cellulose Acetate Film T1)>

Cellulose Acetate Film T1 was produced according to paragraphs [0167] to [0171] of JP-A-2013-79995.

### <Production of Optical Substrates F1 and F10>

Optical Substrates F1 and F10 were produced according to paragraphs [0171] to

of JP-A-2013-79995 by using Cellulose Acetate Film T1 produced above.

### <Production of Polarizing Plate Protective Film 401>

A roll of Optical Substrate F1 produced above was unrolled, and Low Moisture-Permeable Layer-Forming Composition BL-2 was coated on the surface of the optically anisotropic layer by a die coating method using a slot die described in Example 1 of JP-A-2006-122889 under the condition of a conveying speed of 30 m/min and dried at 60° C. for 150 seconds. Thereafter, the coated layer was cured through irradiation with an ultraviolet ray at an illuminance of 400 mW/cm² and an irradiation dose of 350 mJ/cm² by using an air-cooled metal halide lamp (manufactured by Eye Graphics Co., Ltd.) of 160 W/cm under nitrogen purging to an oxygen concentration of about 0.1%, and the film was rolled up to obtain Polarizing Plate Protective Film 401. The coating amount was adjusted such that the film thickness of the low moisture-permeable layer becomes 10 μm.

### <Production of Polarizing Plate Protective Film 402>

Polarizing Plate Protective Film 402 was produced in the same manner as Polarizing Plate Protective Film 401 except that Optical Substrate F1 was changed to F10.

### <Production of Polarizing Plate Protective Films 403 and 404>

Polarizing Plate Protective Films 403 and 404 were produced in the same manner as Polarizing Plate Protective Films 401 and 402, respectively, except that Low Moisture-Permeable Layer-Forming Composition BL-2 was changed to Low Moisture-Permeable Layer-Forming Composition BL-12.

Polarizing Plate Protective Films 401 to 404 were measured for the moisture permeability and pencil hardness in the same manner as Polarizing Plate Protective Film 101 and evaluated for the front retardation Re at a wavelength of 550 nm before and after a light resistance test by the same method as the method described in [0215] of JP-A-2013-79995 except for changing the light irradiation time from 50 hours to 80 hours. The results are shown in Table 4.

TABLE 4

| | | | Liquid | | | | Re after |
|---|---|---|---|---|---|---|---|
| | | | Crystal of | | | | Light |
| | Sample | Transparent | Anisotropic | Optical | Pencil | | Resistance |
| | No. | Support | Layer | Substrate | Hardness | Re (nm) | Test (nm) |
| Example | 401 | T1 | DLC-A | F1 | 3H | 125 | 117 |
| Example | 402 | T1 | RLC | F10 | 3H | 125 | 118 |
| Comparative | 403 | T1 | DLC-A | F1 | 3H | 125 | 100 |
| Example | | | | | | | |
| Comparative | 404 | T1 | RLC | F10 | 3H | 125 | 100 |
| Example | | | | | | | |

The results in Table 4 reveal the followings.

1. The polarizing plate protective film where a low moisture-permeable layer formed by curing a curable composition containing a specific amount of (A) a compound having three or more ethylenically unsaturated double bonds in the molecular and a specific amount of (B) a rosin compound having an acid value of 150 to 400 mgKOH/g is stacked on an optically anisotropic layer formed through alignment of a polymerizable liquid crystal compound and curing, shows little change in the retardation after the light resistance test and is very excellent.

The present invention was described in detail with reference to specific embodiments, but it will be apparent to those of ordinary skill in the art that various changes and modifications can be carried out without departing from the spirit and scope of the present invention.

This application is based on Japanese Patent Application (Patent Application No. 2014-74483) filed on Mar. 31, 2014, the contents of which are incorporated herein by reference.

What is claimed is:

1. A polarizing plate protective film comprising:
a substrate film, and
a layer formed by curing a curable composition containing, setting a total solid content of the curable composition to 100 mass %, from 50 to 90 mass % of the following (A) and from 10 to 40 mass % of the following (B) based on the total solid content:
(A) a compound having three or more ethylenically unsaturated double bonds in the molecule, and
(B) a rosin compound having an acid value of 150 to 400 mgKOH/g.

2. The polarizing plate protective film as claimed in claim 1,
wherein the curable composition contains, as the (A), at least either one of a (meth)acrylate compound and a urethane(meth)acrylate compound.

3. The polarizing plate protective film as claimed in claim 1,
wherein the (B) is at least one rosin compound selected from rosin, a hydrogenated rosin, and an acid-modified rosin.

4. The polarizing plate protective film as claimed in claim 1,
wherein the substrate film is a cellulose acylate film.

5. The polarizing plate protective film as claimed in claim 1,
wherein the substrate film is a (meth)acrylic polymer having, in the main chain, at least one structure of a lactone ring structure, an anhydrous glutaric acid ring structure and a glutarimide ring structure.

6. A method for producing a polarizing plate protective film, comprising:
a step of forming, on a substrate film, a layer by curing a curable composition containing, setting a total solid content of the curable composition to 100 mass %, from 50 to 90 mass % of the following (A) and from 10 to 40 mass % of the following (B) based on the total solid content:
(A) a compound having three or more ethylenically unsaturated double bonds in the molecule, and
(B) a rosin compound having an acid value of 150 to 400 mgKOH/g.

7. A polarizing plate comprising a polarizer and at least one sheet of the polarizing plate protective film claimed in claim 1.

8. A liquid crystal display device comprising:
a liquid crystal cell, and
the polarizing plate claimed in claim 7 disposed on at least one surface of the liquid crystal cell,
wherein the polarizing plate protective film of the polarizing plate is disposed on the outermost surface opposite the liquid crystal cell.
